(19) United States
(12) Patent Application Publication
(10) Pub. No.: US 2025/0043517 A1
(43) Pub. Date: Feb. 6, 2025

(54) Method of Operating an Asphalt Compactor

(71) Applicant: Caterpillar Paving Products Inc., Brooklyn Park, MN (US)

(72) Inventors: Cary M. Bryant, Plymouth, MN (US); Nathaniel S. Doy, Maple Grove, MN (US); Paul R. Friend, Morton, IL (US)

(73) Assignee: Caterpillar Paving Products Inc., Brooklyn Park, MN (US)

(21) Appl. No.: 18/365,387

(22) Filed: Aug. 4, 2023

(51) Int. Cl. E01C 19/00; G05D 1/02

(52) U.S. Cl. CPC E01C 19/004; E01C 19/282

(57) ABSTRACT

A system and method for compacting asphalt or similar materials operates a compactor according to a rolling pattern that involves a plurality of passes in a straight-line direction that terminate in a corresponding plurality of turnouts that deviate from the straight-line direction. The compactor can include one or more sensors and an electronic controller configured to determine the location of a previous turnout. The compactor is propelled spatially past the previous turnout before steering into a subsequent turnout so that the plurality of turnout are spatially staggered and varied.

### TECHNICAL FIELD

This patent disclosure relates generally to operating a compactor to compact material such as asphalt at a worksite and, more particularly, to implementing a rolling pattern for operation of the compactor.

### BACKGROUND

Compaction is a process or step that may be undertaken during a paving operation in which a material such as asphalt or concrete is laid down to form a solid surface. Compaction, in particular, is the application of forces to the material to make it denser, and thus harder and more resistive to wear. For example, in a common paving operation, hot asphalt may be laid down at a worksite by a paving machine that is followed by one or more mobile asphalt compactors. The mobile compactors may include one or more rotating cylindrical drums that can be rolled over the recently laid mat of hot asphalt. The weight of the compactor compresses the granular aggregate of the asphalt into the denser finished paved surface. In addition to relying on the static weight of the compactor, some compactors are configured with vibrating drums to apply additional compaction forces to the asphalt mat.

To achieve the desired density of the finished surface, the compactor may make several passes over the same length of the asphalt mat. Moreover, the compactor may need to make several adjacent passes to correspond with the width of the asphalt mat that may be greater than the cylindrical length of the rolling drum. For example, a compactor may make a first pass in a straight-line pass direction following the paving machine, and then may be reversed to travel along the same width of the asphalt mat, or an adjacent width of the asphalt mat, in a second pass. Travel in either direction is considered a single pass. The series of passes along the same or adjacent widths of the asphalt mat can be referred to as a rolling pattern and can be intended to efficiently produce a finished layer of uniform density.

When completing a first pass in one direction and changing the travel direction of the asphalt compactor to make a second pass, it is desirable that the asphalt compactor is turned or steered away from the straight-line pass direction associated with the first and second passes. For example, the rolling drum is turned at a non-perpendicular angle to the straight-line pass direction so that any material bump, i.e. the transition between the compacted and the un-compacted asphalt, formed by the change in travel direction of the compactor, is arranged at a non-perpendicular angle to the straight-line pass direction that will be associated with subsequent passes of the compactor. Arranging the material bumps at non-perpendicular angles to the straight-line pass direction facilitates smoothing and compacting the material bumps during subsequent passes made by compactor over the angled material bump. The process of steering the compactor to divert from the straight-line pass direction when terminating a pass may be referred to as a turnout.

### SUMMARY

The disclosure describes, in one aspect, a method of operating a compactor in a rolling pattern to compact an asphalt mat. The method includes propelling the compactor in a straight-line pass direction to conduct a first pass and steering the compactor into a first turnout deviating from the straight-line pass direction to terminate the first pass. According to the method, the compactor is propelled in a second pass in the straight-line pass direction to conduct a second pass that is adjacently parallel to the first pass. The method then includes sensing the location of the first turnout and steering the compactor into a second turnout deviating from the straight-line pass direction at a location that is spatially past the first turnout to terminate the second pass.

In another aspect, the disclosure describes an asphalt compaction system that includes a self-propelled compactor configured to make a plurality of passes over an asphalt mat. The compactor can include one or more sensors configured to determine a location of a first turnout that is disposed into the asphalt mat. The asphalt compaction system can also include an electronic controller in electronic communication with the sensor and that is programmed to steer the asphalt compactor into a second turnout that is located spatially past the location of the first turnout.

### BRIEF DESCRIPTION OF THE DRAWINGS

FIG. 1 is a side elevation view of a double drum compactor configured to compact material such as asphalt and that may be configured for autonomous operation.

FIG. 2 is a schematic representation of a rolling pattern over an asphalt mat in which the straight-line passes terminate in angled turnouts that are staggered and spatially varied with respect to each other.

FIG. 3 is a flow diagram of a possible method of spatially staggering or varying the locations of the turnouts to avoid forming material bumps in the asphalt mat.

### DETAILED DESCRIPTION

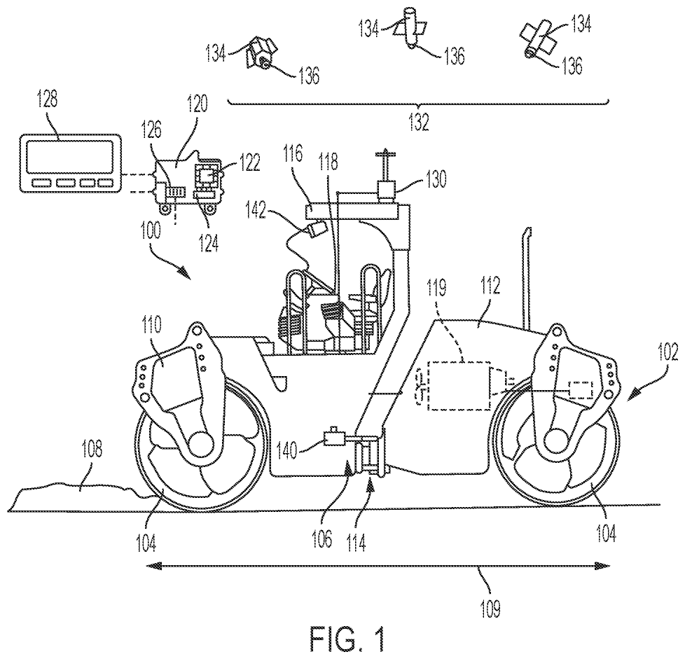

Now referring to the drawings, wherein whenever possible like reference numbers will refer to like elements, there is illustrated in FIG. 1 a compactor 100 in the embodiment of a mobile, double drum asphalt compactor specifically configured to compact asphalt or similar paving material about a worksite 102. The compactor 100 can include one or more roller drums 104 that are attached to a machine frame or compactor chassis 106. The roller drums 104 can be shaped as large diameter cylinders that are rotatable with respect to the compactor chassis 106 and can be weighted with a ballast or additional weight to improve compaction. The roller drums 104 may have a smooth cylindrical exterior surface, although in other embodiments, the exterior of the drums 104 may include texturing such as knobs, pads, and the like to facilitate compaction.

In some embodiments, the compactor 100 can be a vibratory compactor and the roller drums 104 can be operatively associated with eccentric weights, for example, located inside the cylindrical shell of the roller drums 104. The eccentric weights can be made to rotate creating forces that cause the roller drums 104 to vibrate with respect to the worksite 102. The vibration forces applied to the asphalt mat improves compacting the loose aggregate asphalt into the denser finished layer.

In an asphalt paving operation, aggregate asphalt is laid and spread over the worksite 102 by, for example, a paving machine equipped with a screed, thereby depositing an asphalt mat 108. To compress the loosely combined aggregate, the compactor 100, which is mobile and capable of being propelled about the worksite 102, is propelled over the asphalt mat 108 with respect to a travel orientation 109 by, for example, powered rotation of the roller drums 104 with respect to the compactor chassis 106.

A compactor 100 intended for compacting asphalt and similar materials in a paving operation may be configured with roller drums 104 of the same shape and diameter at both a front chassis end 110 and rear chassis end 112 of the compactor chassis 106. Because of the forward and rearward locations of the roller drums 104, the compactor 100 is therefore able to compact material while traveling in either direction with respect to the travel orientation 109. In other embodiments, however, the compactor 100 can have different configurations such as, for example, having one or more propulsion/traction devices like pneumatic wheels or continuous tracks in place of one of the roller drums 104.

In an embodiment, to facilitate steering the compactor 100 with respect to the travel orientation 109, the compactor chassis 106 can be articulated with the front chassis end 110 and the rear chassis end 112 coupled together by an articulation joint 114. The compactor 100 can be operatively associated with an articulated steering system having steering controls and hydraulic actuators or pistons that cause the front and rear chassis ends 110, 112 to pivot and turn the compactor 100 with respect to the travel orientation 109, however, other steering configurations may be used with the compactor 100.

To accommodate operator input devices 118 such as steering controls and other operational controls, the compactor 100 can include an onboard operator cab 116 disposed on the compactor chassis 106. Examples of operator input devices may include a steering wheel, forward-neutral-reverse controls, accelerators and brakes, and the like. To power the compactor 100, including by providing motive power to the roller drums 104, a power plant 119 such as an internal combustion engine, a hybrid internal combustion/electric drive system, or an electric motor can also be disposed on the compactor chassis 106.

While in an embodiment, an operator can manually operate the compactor 100 from the onboard operator cab 116, in other embodiments, the compactor 100 can be configured for remote operation wherein an operator at a remote, off board location operates the compactor through remote controls. In a further embodiment, the compactor 100 can be configured for fully autonomous operation in which the compactor 100 operates according to a rolling pattern without operator input and is configured to be automatically responsive to external and environmental conditions and occurrences when conducting a paving operation.

To facilitate autonomous operation, the compactor 100 can be operatively associated with an electronic controller 120, which may also be referred to as an electronic control module (“ECM”) electronic control unit (“ECU”), or just a controller. The electronic controller 120 can be a programmable computing device and can include one or more microprocessors 122 for executing software instructions and processing computer readable data. Examples of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip. Although illustrated as a single component, in other embodiments, the functionality of the electronic controller 120 may be distributed among a plurality of separate components. In addition, the electronic controller 120 may be located onboard the compactor 100 although in other embodiments some or all of the functionality may occur off board or remote from the compactor 100.

To store application software and data, the electronic controller 120 can include a non-transitory computer readable and/or writeable data memory 124, for example, read only memory (“ROM”), random access memory (“RAM”), EPROM memory, flash memory, or another more permanent storage medium like magnetic or optical storage. To interface and network with other operational systems, the electronic controller 120 can include an input/output interface 126 to electronically send and receive non-transitory data and information. The input/output interface 126 can be physically embodied as data ports, serial ports, parallel ports, USB ports, jacks, and the like to communicate via conductive wires, cables, optical fibers, or other communicative bus systems. To communicate with other operational system, the electronic controller 120 can utilize any suitable forms of communication protocol for data communication including sending and receiving digital or analog signals synchronously, asynchronously, or elsewise.

To interact with an operator, who may be located onboard or off-board the compactor 100, the electronic controller 120 can be operatively associated with an input/output interface such as an operator interface display 128, also referred to as a human-machine interface (“HMI”). The operator interface display 128 can be an output device to visually present information to a human operator regarding operation of the compactor 100. The operator interface display 128 can be a liquid crystal display (“LCD”) capable of presenting numerical values, text descriptors, graphs, charts and the like regarding operation. The operator interface display 128 may have capacities such as a touchscreen to receive input from a human operator, although in other embodiments, other interface devices may be included such as dials, knobs, switches, keypads, keyboards, mice, printers, etc.

To communicate with remotely located systems and/or individuals, the compactor 100 can include a transceiver 130 associated with the electronic controller 120 and physically located at an exposed location on compactor chassis 106. The transceiver 130 is able to transmit and receive communication signals using wireless protocols such as radio, Wi-Fi, Bluetooth, or cellular communications. In an embodiment, the transceiver 130 can be an antenna that can convert signals and data between radio waves propagating through space and electrical currents that can be transferred through conductors and be processed by the electronic controller 120.

For example, to determine the positions or locations of the compactor 100 about the worksite 102, the transceiver 130 can be associated and communicate with a position determining system that may be implemented in any suitable form. For example, the position determining system can be realized as a global navigation satellite system (GNSS) or global positioning satellite (GPS) system 132. In the GNSS or GPS system 132, a plurality of manmade satellites 134 orbit about the earth at fixed or precise trajectories. Each satellite 134 includes a positioning transmitter 136 that transmits positioning signals encoding time and positioning information towards earth. By calculating, such as by triangulation, between the positioning signals received from different satellites, one can determine their instantaneous location on earth. In the present embodiment, the transceivers 130 on the compactor 100 can be configured to also receive the positioning signals from the positioning transmitters 136.

To detect and assess conditions about the worksite 102, for example, the compaction state of the asphalt mat 108, the compactor 100 can include one or more sensors 140 disposed about the compactor chassis 106. The sensors 140 can be operatively associated with the electronic controller 120 that can process and analyze the information and data obtained from the sensors. In a particular embodiment, the electronic controller 120 can determine certain physical characteristics about the asphalt mat 108 or similar regions of material that is being compacted. The electronic controller 120 can process the obtained information and data from the sensors 140 to assist in the compacting operation of the compactor 100, including for example, during fully autonomous operation. As described in further detail below, the sensors 140 may be any suitable sensors for detecting events, conditions, or changes in an environment and signaling that information or data to another system and/or outputting it directly to an observer. Examples of sensors 140 include force sensors, spatial sensors such as rangefinders, acoustic sensors, light or image sensors, electrically conductive or resistive sensors, etc.

In addition to or as an example of a sensor 140, the compactor 100 may be operatively associated with one or more cameras 142 or similar image capturing devices disposed about the compactor chassis 106. The cameras 142 may be still image cameras, video cameras, smart cameras, etc. and can include features that enable the camera to focus at different locations or depth perceptions. The cameras 142 are capable of capturing an image of the worksite 102 in which the compactor 100 is operating, for example, in the form of a digitally captured video, that can be viewed and analyzed to assess certain physical characteristics about the worksite. For example, the data stream of the images captured by the cameras 142 can be communicated to the electronic controller 120 for further processing and analysis. The captured images can also be presented on the operator interface display 128 for an operator to view either onboard the compactor 100 or remotely.

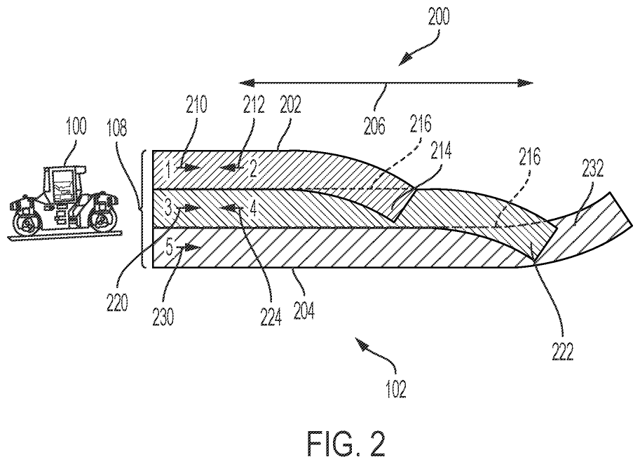

During compaction, compactors 100 are typically moved or propelled about the worksite 102 in accordance with a rolling pattern, which is the series of movements and passes made by the compactor to produce a final layer of compacted material of desired density and area. Referring to FIG. 2, there is schematically illustrated a representative rolling pattern 200 that may be conducted to compress a freshly laid asphalt mat 108. The asphalt mat 108 may have been deposited at the worksite 102 as a continuous strip by a forward moving paving machine and can be characterized as having a width defined between a first unconfined edge 202 and a parallel second unconfined edge 204. The elongated asphalt mat 108 can generally align with a straight-line pass direction 206 of travel associated with the compactor 100 in either forward or reverse. Because the width of the asphalt mat 108 between the first and second unconfined edges 202, 204 may be wider than the axial or cylindrical length of the roller drums on the compactor 100, the compactor may have to make multiple, adjacently offset passes across the width of the asphalt mat 108.

In accordance with the embodiment of FIG. 2, the rolling pattern 200 is initiated by propelling the compactor 100 along a first pass 210 over the asphalt mat 108. The first pass 210 is elongated and straight, and can be accomplished by propelling the compactor 100 in alignment with the straight-line pass direction 206 without curvature or deviation.

To terminate the first pass 210 and to begin the second pass 212 oppositely directed with respect to the straight-line pass direction 206, the compactor 100 must stop and reverse on the hot asphalt mat 108. To avoid the formation of material bumps on the asphalt mat 108 where the first pass 210 has terminated, such as may be caused by displacing the granular and loosely combined asphalt along the first pass via the roller drums which may collect at the terminal end of the first pass, the compactor 100 is steered into a first turnout 214. The first turnout 214 can be accomplished by turning the compactor 100 toward or into one un-compacted edge 216 of the un-compacted material of the asphalt mat 108 so as to divert from the straight-line pass direction 206. The un-compacted edges 216, indicated in dashed lines, are formed at the interface between compacted material that the compactor 100 has traversed over and un-compacted material the compactor has yet to encounter, and is characterized by the dimensional difference in vertical height or thickness of the asphalt mat 108 between the two regions of compacted and un-compacted material.

If the first pass 210 is made along the first unconfined edge 202 of the asphalt mat 108, the first turn out 214 can be made by steering the compactor 100 toward the second unconfined edge 204 and into the center of the asphalt mat 108. The first turnout 214 should result in the roller drums arranged at an approximately 30 degree angle with respect to the straight-line pass direction 206. The second pass 212 is initiated by reversing the compactor 100 from the first turnout 214 and may be superimposed over the first pass 210, resulting in further compaction and increased density of the asphalt mat 108 within that elongated area.

The compactor 100 can make a third pass 220 aligned along the straight-line pass direction 206 and that is adjacent and parallel to the first and second passes 210, 212. For example, the third pass 220 can correspond to the center of the asphalt mat 108 mid-width between the first and second unconfined edges 202, 204. To terminate the third pass 220, the compactor is steered into a second turnout 222 that diverts from the straight-line pass direction 206. For example, the compactor 100 can be steered towards the un-compacted edge 216 remaining on the asphalt mat 108 and that corresponds to the interface between compacted and un-compacted asphalt.

To compact the material bump formed by the termination of the first pass 210 and corresponding to the first turnout 214, the second turnout 222 that terminates the third pass 220 should be located beyond or spatially past the first turnout 214. The third pass 220 thus spatially extends beyond the first turnout 214. Since the paving machine is continuously moving forward, the length of the asphalt mat 108 will be extended to accommodate the extension of the third pass 220 beyond the first turnout 214. Because any material displacement or material bump formed by termination of the first pass 210 and the first turnout 214 will be deposited in and aligned with the third pass 220, the compactor 100 will be propelled over that displaced material ensuring an even surface of uniform density is formed by the compactor 100. Once the compactor 100 has conducted the second turnout 212, the compactor can be placed in reverse during a fourth pass 224 in the straight-line pass direction 206 that aligns with and is superimposed over the third pass 220 resulting in further compaction of the material within that respective area.

The compactor 100 can make a fifth pass 230 along the second unconfined edge 204 of the asphalt mat 108 in the straight-line pass direction 206 that is adjacent and parallel to the third pass 220. The fifth pass 230 can terminate in a third turnout 232 that also deviates from the straight-line pass direction 206. To compact the material bump formed by the termination of the third pass 220 and the corresponding second turnout 222, the third turnout 232 should be located beyond or spatially past the second turnout 222. In addition, the second turnout 222 can be made by steering the compactor 100 oppositely as was done to form the first and second turnouts 214, 222. In other words, the compactor 100 is steered back into the middle of the asphalt mat 108 mid-width between the first and second unconfined edges 202, 204. As shown in FIG. 2, the disclosed rolling pattern 200 results in a plurality of spatially staggered or varied turnouts, 214, 222, 232 over the length of the asphalt mat 108 that reduces or eliminates material bumps formed during the termination of passes of the compactor 100.

### INDUSTRIAL APPLICABILITY

The present configuration of a compactor 100 with sensors 140 and/or cameras 142 to sense and detect the physical characteristics of the surrounding worksite 102 can facilitate operation of the compactor 100 in accordance with a rolling pattern 200 such as described above. The disclosure may be particularly applicable and advantageous when the compactor 100 is configured for autonomous operation without the presence or assistance of an operator. For example, the inclusion of sensors 140 and/or cameras 142 on the compactor 100 enables it to automatically and positively react to conditions about the worksite 102 to implement the rolling pattern 200 to improve compaction of the asphalt and produce a continuous finished surface of uniform density.

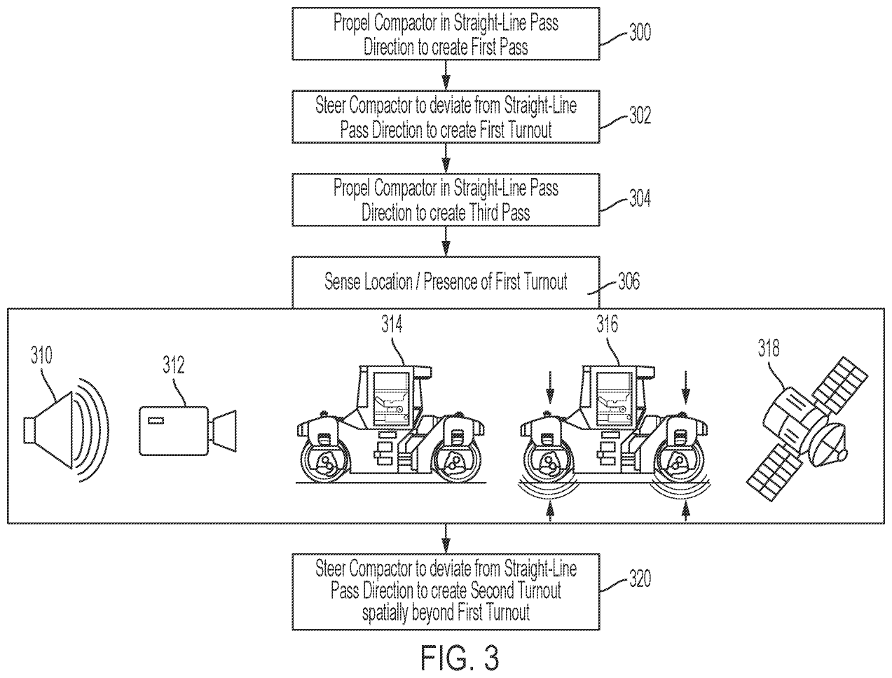

For example, referring to FIG. 3, with continued reference to the prior figures, there is illustrated an example of routine or process in which compactors 100, which may be self-propelled and autonomous, can operate in accordance with a rolling pattern 200 to eliminate the formation of material bumps. In an initial first propulsion step 300, the compactor 100 is propelled to conduct a first pass 210 that may be generally aligned with a straight-line pass direction 206 over the asphalt mat 108. In a first turnout step 302, the compactor 100 terminates the first pass 210 by steering into a first turnout 214 that deviates from the straight-line pass direction 206. The termination location of the first turnout 214 therefore does not align with the otherwise straight first pass 210 that corresponds to the straight-line pass direction 206.

In a subsequent second propulsion step 304, the compactor 100 is again propelled over the asphalt mat 108 aligned with the straight-line pass direction 206 to create a third pass 220. The third pass 220 can be parallel and adjacent to the first pass 210. In an embodiment, the first pass 210 and the third pass 220 can partially overlap to compact any un-compacted material there between. To ensure that the third pass 220 spatially extends beyond and thus over and past the first turnout 214, the compactor 100, which may be autonomous, can conduct a turnout sensing step 306 that utilizes the sensors 140 and/or cameras 142 to detect the location of the first turnout 214. As stated above, the sensors 140 and/or cameras 142 can be any suitable type of sensor or may use any suitable operating principle to sense the first turnout 214. FIG. 3 schematically represents a plurality of possible sensing and/or imaging technologies that can be used to determine the location of the first turnout.

For example, the spatial locations of the previously compacted first pass 210 and the presently compacted third pass 220 are differentiated by the un-compacted edge 216. To determine the location of the un-compacted edge 216, the sensors 140 may be reflective sensors 310 that utilize a reflective technology such as acoustics or light waves. In particular, a wave is emitted from the reflective sensor 310 located on the compactor 100 toward the surface of the asphalt mat 108, where the wave is reflected back to and detected by the sensor. In a particular embodiment, the reflective sensor 310 can be a rangefinder configured to determine the distance between the sensor from which the wave is emitted and the surface from which the wave is reflected. The elapsed time the wave travels from the reflective sensor 310 to the asphalt mat 108 and back can be converted to spatial coordinates and thus analyzed to determine the location of the un-compacted edge 216. RADAR and LIDAR are suitable examples of rangefinder reflective sensors 310. If the reflective sensor 310, in cooperation with the electronic controller 120, senses that that un-compacted edge 216 is deviating from the straight-line pass direction 206, the electronic controller 120 may interpret that deviation as signifying the location of the first turnout 214. The electronic controller 120 can propel the compactor 100 spatially beyond the first turnout 214 before steering into the second turnout 222 that deviates from the straight-line pass direction 206.

In another embodiment, the cameras 142, functioning as the sensors, act as visual sensors 312 utilizing and analyzing visual images to sense and determine the location of the first turnout 214. For example, the visual sensor 312 can be a camera or a smart camera capable of capturing images of the asphalt mat 108. The smart camera, possibly in cooperation with the electronic controller 120, can analyze the image for deviation in the alignment of the un-compressed edge 216. As another example, the visual sensor 312 can utilize pattern recognition and/or visually perceptible colorization or shading differences to discern between the compacted and the un-compacted areas of the asphalt mat 108 and thus locate the un-compacted edge 216. For example, a greater degree of compaction may be associated with denser or darker patterns or colors. The electronic controller 120 can analyze the visual information obtained from the visual sensor 312 to determine the location of the first turnout 214 and propel the compactor 100 spatially beyond that location.

In another embodiment, the sensors 140 can be resistive forces sensors 314 that measure the resistance to propulsion of the compactor 100 over the worksite 102 caused by the presence of un-compacted asphalt on the asphalt mat 108. For example, the aggregate asphalt in the un-compacted state presents greater rolling resistance to the rotation of the rolling drums 104 on the compactor 100, thus necessitating that the compactor 100 expend more energy to propel itself with respect to the asphalt mat 108. A sudden change in the energy expended, such as when the compactor 100 travels from an area of un-compacted material to an area of compacted material such as would corresponding to the first turnout 214, can indicate to the electronic controller 120 the location of the first turnout. To implement the resistive force sensors 314, the electronic controller 120 can measure the energy expenditure via fuel consumption or battery discharge rates and indirectly assess the energy expended to propel the compactor 100 about the worksite, and thereby determine the rolling resistance presented by either the compacted or un-compacted asphalt of the asphalt mat 108.

In another embodiment, the sensors 140 can be vibration sensors 316 that measure vibratory forces reflected from the worksite 102. For example, the compactor 100 can be a vibratory compactor with eccentric weights that cause the rolling drums 104 to vibrate with respect to, and on top of, the asphalt mat 108. If the asphalt mat 108 is in the un-compacted state, the imparted vibration forces will be substantially dissipated during compaction. If the asphalt mat 108 is in the compacted state, i.e., denser material, a substantial portion of the vibration forces may be reflected back to the compactor 100. The vibration sensors 316 can sense the magnitude of the reflected vibration forces to determine if the compactor 100 is traveling over compacted or un-compacted asphalt. The vibration sensors 316 may be accelerometers that detect acceleration or small changes in velocity that occur when the vibration forces are reflected back and applied to the compactor chassis 106.

In another embodiment, the sensors 140 can be associated with a satellite navigation system 318 such as a GNSS system. For example, the transceiver 130 on the compactor 100 can communicate with the satellite navigation system 318 comprised of a plurality of satellites 134 transmitting navigation signals. The electronic controller 120 can process and analyze the navigation signals received by the transceiver 130 from the satellite navigation system 318 to determine the location of the compactor 100 about the worksite 102. When the compactor 100 is steered into the first turnout 214, indicated for example when the compactor stops and reverses travel direction, the electronic controller 120 can demark the location of the first turnout 214, for example, on a digital map that can be stored in memory. During the subsequent third pass 220, the electronic controller 120, while continuing to utilize the satellite navigation system 318, can determine if the compactor 100 is spatially past or beyond the first turnout 214 before initiating the second turnout 222.

In an embodiment, the electronic controller 120 can use the satellite navigation system 318 as part of a pass mapping system. In pass mapping, the electronic controller 120 can use the satellite navigation system 318 to determine the current location and all previous locations of the compactor 100 with respect to the rolling pattern 200. The previous locations can be presented as part of a digital map or the like stored in the memory 124 of the electronic controller 120. The electronic controller 120 can compare the current location of the compactor 100, as determined via the satellite navigation system 318, with the digital map of previous locations to indicate where the compactor is in completing the designated rolling pattern. As part of mapping the previous locations, the pass mapping system may also map previous passes and turnouts, and use those in conducting the disclosed rolling pattern 200 wherein subsequent turnouts are spatially staggered with respect to previous turnouts.

With continued reference to FIG. 3, once the electronic controller 120 in cooperation with the sensors 140 and/or cameras 142 have determined the location of the first turnout 214, the electronic controller 120 can cause the compactor 100 to travel past the location of the first turnout 214 before initiating a second steering step 320. The second steering step 320 turns the compactor 100 to deviate from the straight-line pass direction 206 to create the second turnout 222. Since the electronic controller 120, the sensors 140, and/or the cameras 142 have verified that the compactor 100 is spatially past the first turnout 214, the compactor 100 will have necessarily propelled over and compacted any material bumps formed during the prior turnout and disposed in the path of the current pass of the compactor. The disclosure thus provides a rolling pattern 200 that may be conducted by an autonomous compactor in which a plurality of turnouts are spatially staggered and varied with respect to each other.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of operating a compactor in a rolling pattern on an asphalt mat comprising:
propelling the compactor in a straight-line pass direction to conduct a first pass;
steering the compactor into a first turnout deviating from the straight-line pass direction to terminate the first pass;
propelling the compactor in a second pass in the straight-line pass direction to conduct a second pass that is adjacently parallel to the first pass;
sensing the first turnout; and
steering the compactor into a second turnout deviating from the straight-line pass direction spatially past the first turnout to terminate the second pass.

2. The method of claim 1, wherein the step of sensing the first turnout utilizes a visual sensor to sense a deviation in an un-compacted edge.

3. The method of claim 1, wherein the step of sensing the first turnout utilizes a visual senor configured for pattern recognition or color differentiation.

4. The method of claim 1, wherein the step of sensing the first turnout utilizes a reflective sensor to sensing a deviation in an un-compacted edge.

5. The method of claim 4, wherein the reflective sensor is a rangefinder configured to determine distance to the asphalt mat to sense deviation in an un-compacted edge.

6. The method of claim 1, wherein the step of sensing the first turnout utilizes a force sensor responsive to mechanical forces.

7. The method of claim 6, wherein the force sensor is a vibration sensor that senses a compaction state of the asphalt mat.

8. The method of claim 6, wherein the force sensor is a resistive force sensor that senses a compaction state of the asphalt mat.

9. The method of claim 1, wherein the compactor includes a GNSS transceiver to mark a location of the first turnout on the asphalt mat through pass mapping.

10. The method of claim 1, wherein the compactor is autonomous.

11. An asphalt compaction system comprising:
a compactor that is self-propelled to make a plurality of passes over an asphalt mat;
at least one sensor disposed on the compactor and configured to determine a location of a first turnout disposed into the asphalt mat;
an electronic controller in electronic communication with said at least one sensor and programmed to steer the asphalt compactor into a second turnout located spatially past the location of the first turnout.

12. The asphalt compaction system of claim 11, wherein the at least one sensor is configured to sense an un-compacted edge disposed into an asphalt mat.

13. The asphalt compaction system of claim 12, wherein the at least one sensor is a reflective sensor emitting waves towards the asphalt mat and receiving reflected waves back.

14. The asphalt compaction system of claim 11, wherein the at least one sensor is a visual sensor configured to capture an image of the asphalt mat.

15. The asphalt compaction system of claim 14, wherein the visual sensor is a smart camera configured for pattern recognition or color differentiation.

16. The asphalt compaction system of claim 11, wherein the at least one sensor is a force sensor responsive to mechanical forces.

17. The asphalt compaction system of claim 16, wherein the force sensor is a vibration sensor that senses a compaction state of the asphalt mat.

18. The asphalt compaction system of claim 16, wherein the force sensor is a resistive force sensor that senses a compaction state of the asphalt mat.

19. The asphalt compaction system of claim 11, wherein the at least one sensor is a GNSS transceiver and the electronic controller is programmed to mark a location of the first turnout on the asphalt mat through pass mapping.

20. The method of claim 1, wherein the compactor is autonomous.
